(19) United States
(12) Patent Application Publication
(10) Pub. No.: US 2025/0153395 A1
(43) Pub. Date: May 15, 2025

(54) LATERAL SUPPORT DEVICE FOR TILE CUTTER

(71) Applicant: REXON INDUSTRIAL CORPORATION LTD., TAICHUNG CITY (TW)

(72) Inventor: XIN-HAO HUANG, TAICHUNG CITY (TW)

(21) Appl. No.: 18/947,207

(22) Filed: Nov. 14, 2024

(30) Foreign Application Priority Data
Nov. 14, 2023 (TW) 112143922

(51) Int. Cl. B28D 7/04; B28D 1/24

(52) U.S. Cl. CPC B28D 7/043; B28D 1/24

(57) ABSTRACT

A lateral support device includes a fixed seat mounted to a worktable, a lateral support plate having a sliding groove, and a pivot seat pivoted to the fixed seat and having a pressing portion arranged adjacent to the lateral support plate. A lock assembly has a pressing plate disposed to the pivot seat and arranged adjacent to the lateral support plate, a threaded rod threaded with the pressing plate through the pressing portion and the sliding groove, and a handle fixed to one end of the threaded rod. When the handle is locked, the lateral support plate is forced tightly and cannot be moved, and when the handle is unlocked, the lateral support plate is released and can be moved relative to the worktable for adjusting its position. Thus, the present invention provides lateral support to workpieces of different sizes for improving issues with incomplete cross-sections.

### BACKGROUND OF THE INVENTION

### 1. Field of the Invention

The present invention relates to tile cutters and more particularly, to a lateral support device that is used for a tile cutter.

### 2. Description of the Related Art

Due to the inherently brittle and hard texture of tiles, general cutting tools cannot be used for cutting them. Instead, a tile cutter specifically designed for this purpose must be employed. Before using the tile cutter to saw the tile, the tile should be placed on the worktable and pressed against the stop, which helps to position the tile and prevent any movement during the cutting process. The tile is then pushed towards the cutting device by using the worktable, allowing the tile to be cut to the desired size by the saw during the movement.

However, during the cutting process, the force applied to the tile along its edges is often uneven, which can cause the tile to crack or show fracture marks when it is nearly cut through. This results in an uneven break, requiring the operator to spend additional time smoothing out the rough edges, thus increasing the operational difficulties and reducing overall work efficiency.

### SUMMARY OF THE INVENTION

It is one objective of the present invention to provide a lateral support device for use with a tile cutter, which can provide lateral support to workpieces of different sizes for improving issues with incomplete cross-sections.

To attain the above objective, the lateral support device of the present invention comprises a fixed seat, a lateral support plate, a pivot seat, and a lock assembly. The fixed seat is mounted to a lateral side of a worktable. The lateral support plate has a first lateral surface, a second lateral surface opposite to the first lateral surface, and a sliding groove passing through the first and second lateral surfaces. The pivot seat is pivotally connected with the fixed seat and has a pressing portion arranged adjacent to the first lateral surface of the lateral support plate, and a perforation passing through the pressing portion and communicating with the sliding groove of the lateral support plate. The lock assembly includes a pressing plate detachably connected to the pivot seat and arranged adjacent to the second lateral surface of the lateral support plate and having a threaded hole communicating with the sliding groove, a threaded rod passing through the perforation and the sliding groove and having one end threaded with the threaded hole, and a handle fixed to an opposite end of the threaded rod.

It can be seen from the above that when the handle is located at a lock position, the lateral support plate is forced tightly between the pressing portion of the pivot seat and the pressing plate, such that the lateral support plate cannot be moved relative to the worktable, and when the handle is located at an unlock position, the lateral support plate is released by the pressing portion of the pivot seat and the pressing plate, such that the lateral support plate can be moved relative to the worktable through the sliding groove. That is to say, the lateral support device of the present invention can adjust the position of the lateral support plate according to workpieces of different sizes, so that the lateral support plate can provide effective lateral support to workpieces of different sizes for solving issues with incomplete cross-sections.

Preferably, the lateral support plate further includes a first end surface, a second send surface, a stop surface, and a bottom surface. The first and second end surfaces are connected with two opposite ends of the first and second lateral surfaces, respectively. The outer periphery of the top surface and the outer periphery of the bottom surface are connected with the first and second lateral surfaces and the first and second end surfaces, respectively. The sliding groove is located between the first end surface, the second end surface, the top surface, and the bottom surface.

Preferably, when the handle is located at the unlock position, the lateral support plate is flippable between a first position and a second position through the pivot seat. When the lateral support plate is located at the first position, the lateral support plate is located above the worktable, and the bottom surface of the lateral support plate faces towards a working plane of the worktable, such that the lateral support plate provides lateral support to the workpiece when the handle is locked. When the lateral support plate is located at the second position, the lateral support plate protrudes from the lateral side of the worktable, and the bottom surface of the lateral support plate is flushed with the working plane of the worktable, such that the lateral support plate can be used as an extension platform to assist the worktable in providing support for longer workpieces when the handle is locked.

Preferably, when the lateral support plate is located at the second position, a stop portion of the pivot seat is abutted against a bottom surface of the fixed seat to ensure that the lateral support plate is positioned without excessive flipping.

Preferably, the pressing plate has an insertion block inserted into an insertion groove of the pivot seat. In this way, when driven by the threaded rod, the pressing plate is moved towards the second lateral surface of the lateral support plate, thereby applying tight positioning to the lateral support plate.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a lateral support device of the present invention installed in a tile cutter.

FIG. 2 is a perspective view of the lateral support device of the present invention.

FIG. 3 is an exploded view of the lateral support device of the present invention.

FIG. 4 is a sectional view of the lateral support device of the present invention.

FIG. 5 is a perspective view of the lateral support device of the present invention used with the tile cutter, showing that the lateral support plate is located at the first position and the handle is located at the lock position.

FIG. 6 is similar to FIG. 5, showing that the handle is located at the unlock position.

FIG. 7 is similar to FIG. 6, showing that the lateral support plate is adjusted to a different position.

FIG. 8 is similar to FIG. 5, showing that the lateral support plate is located at the second position.

FIG. 9 is a lateral view of the lateral support device of the present invention used with the tile cutter, showing that the lateral support plate is located at the second position.

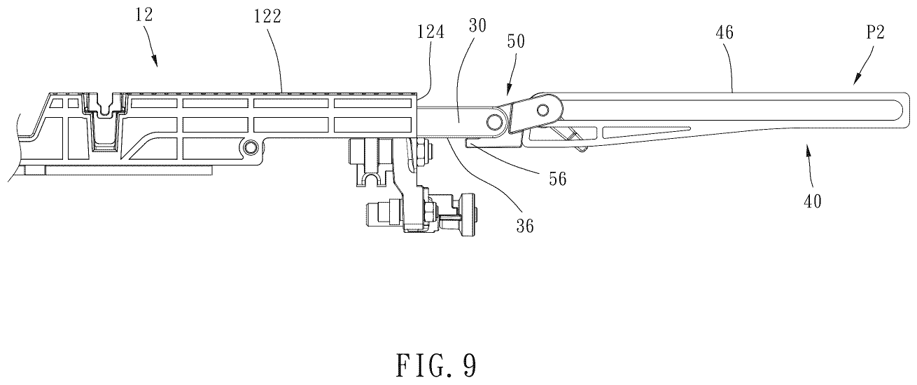

FIG. 10 is similar to FIG. 8, showing that the lateral support plate assists the worktable in providing support for longer workpieces.

### DETAILED DESCRIPTION OF THE INVENTION

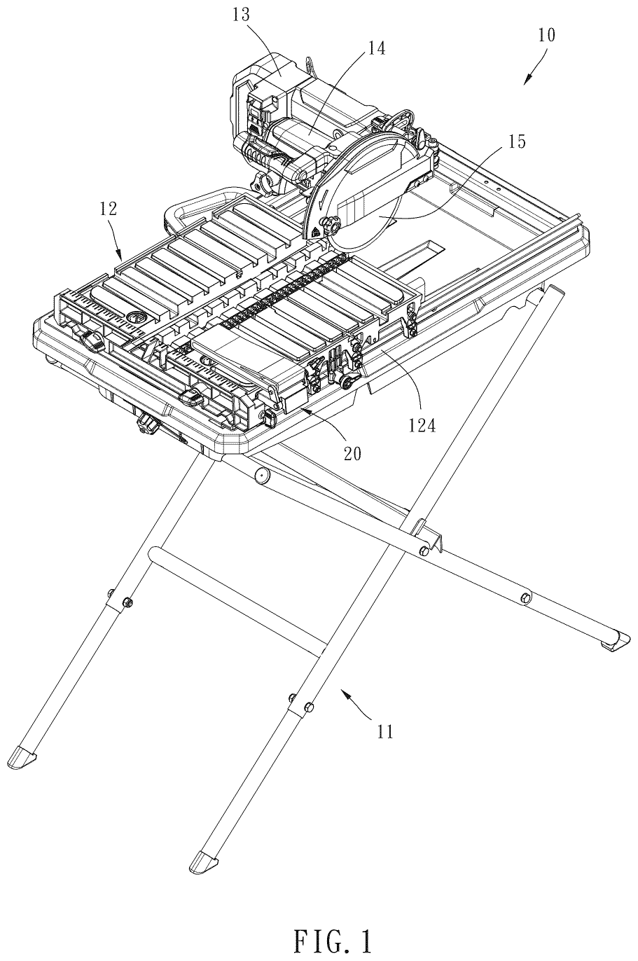

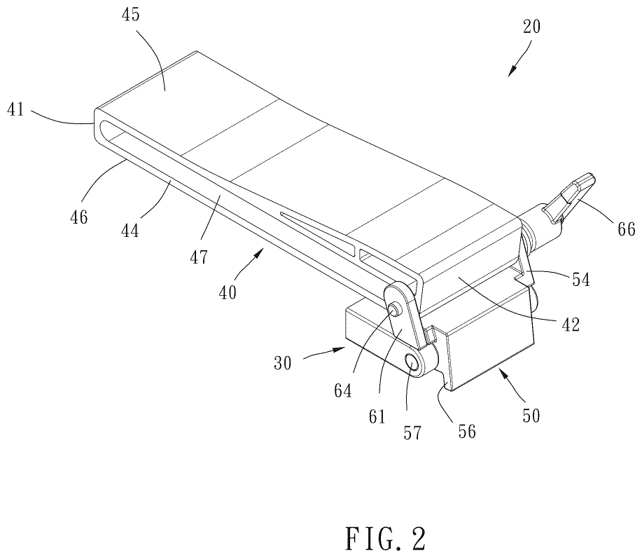

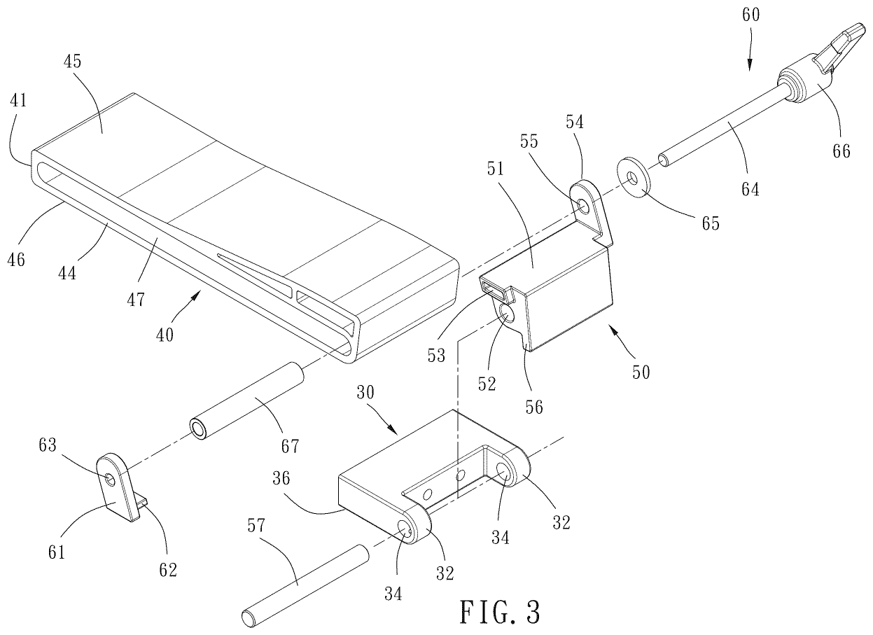

Referring to FIG. 1, a lateral support device 20 of the present invention is used for a tile cutter 10. The tile cutter 10 as shown in FIG. 1 comprises a support stand 11, a worktable 12 supported by the support stand 11, a saw arm 13 pivotally connected with the worktable 12, a motor 14 mounted to the saw arm 13, and a saw blade 15 attached to the saw arm 13 and connected with the motor 14. The worktable 12 includes a working plane 122 for placing a workpiece W (such as a tile). Since the tile cutter 10 is not the key point of the present invention, the detailed configuration and operational theorem thereof will not be repeatedly mentioned hereunder. Referring to FIGS. 2 and 3, the lateral support device 20 of the present invention comprises a fixed seat 30, a lateral support plate 40, a pivot seat 50, and a lock assembly 60.

The fixed seat 30 is secured to a lateral side 124 of the worktable 12 by using two screws (not shown). Two opposite ends of the outer surface of the fixed seat 30 each have a ear portion 32 and a fixed hole 34 passing through the ear portion 32.

The lateral plate 40 is located above the fixed seat 30. The lateral plate 40 includes a first end surface 41, a second end surface 42, a first lateral surface 43, a second lateral surface 44, a top surface 45, and a bottom surface 46. The first and second lateral surfaces 43, 44 are opposite to each other, and the front and rear ends of the first lateral surface 43 and the front and rear ends of the second lateral surface 44 are connected to the first end surface 41 and the second end surface 42, respectively. The outer periphery of the top surface 45 and the outer periphery of the bottom surface 46 are connected to the first end surface 41, the second end surface 42, the first lateral surface 43, and the second lateral surface 44, respectively. Additionally, the lateral support plate 40 further has a sliding groove 47 located between the first end surface 41, the second end surface 42, the top surface 45, and the bottom surface 46 and passing through the first and second lateral surfaces 43, 44.

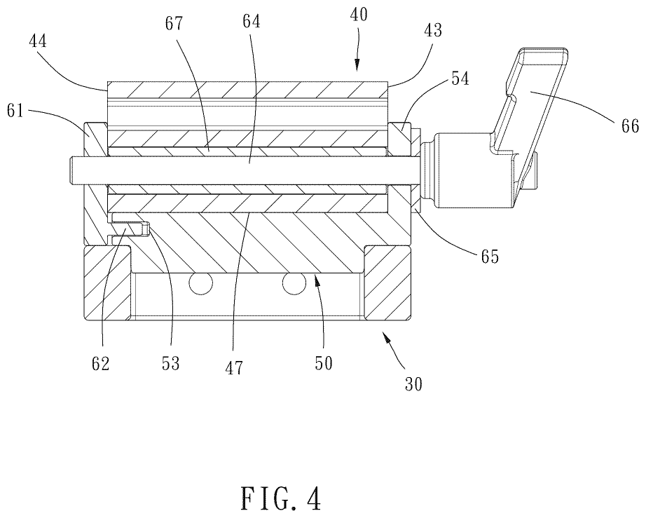

The pivot seat 50 includes a support portion 51, a pressing portion 54, and a stop portion 56. The support portion 51 has a pivot hole 52 passing through two end surfaces thereof, and one end of the support portion 51 has an insertion groove 53 located above the pivot hole 52. The pressing portion 54 protrudes integrally upward from the other end of the support portion 51 and has a perforation 55. The stop portion 56 protrudes integrally downward from the outer surface of the support portion 51. As shown in FIGS. 3 and 4, a pivot 57 is penetrated into the two fixed holes 34 of the ear portions 32 of the fixed seat 30 and the pivot hole 52 of the support portion 51 of the pivot seat 50, such that the pivot seat 50 is pivotally connected with the fixed seat 30 so as to be pivotable upward and downward relative to the fixed seat 30. After the assembly is completed, the pressing portion 54 is adjacent to the first lateral surface 43 of the lateral support plate 40, and the perforation 55 is connected to the sliding groove 47 of the lateral support plate 40.

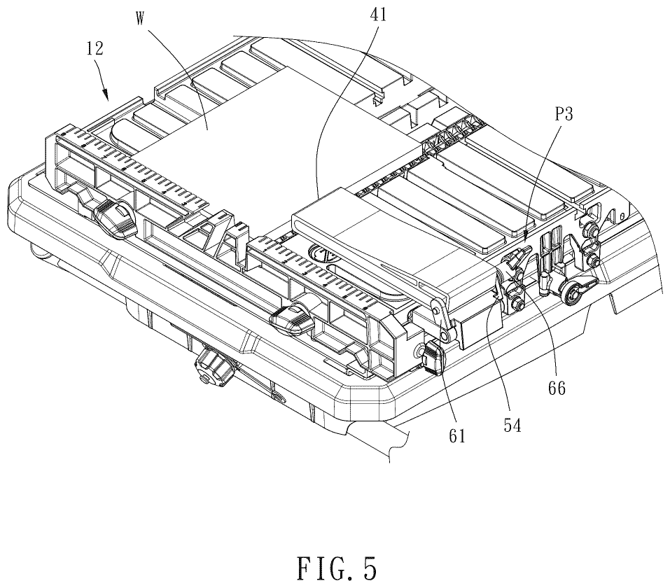

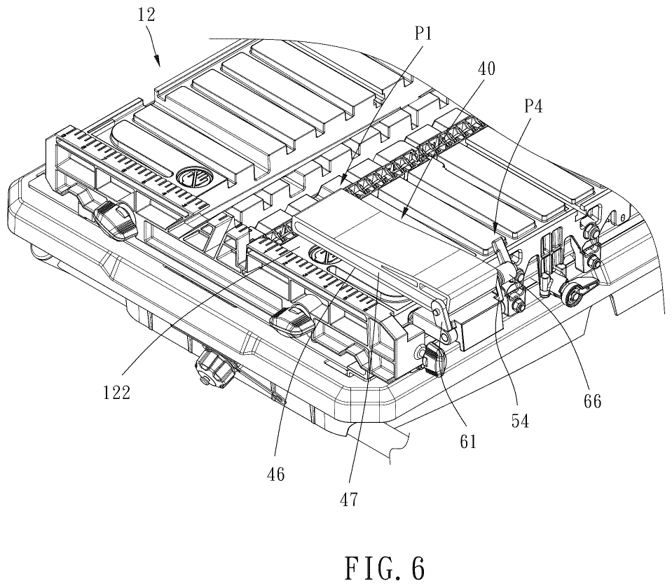

The lock assembly 60 includes a pressing plate 61, a threaded rod 64, a handle 66, and a bushing 67. As shown in FIGS. 3 and 4, the bottom end of the pressing plate 61 has an insertion block 62. The pressing plate 61 is adjacent to the second lateral surface 44 of the lateral plate 40 and uses the insertion block 62 to insert into the insertion groove 53 of the pivot seat 50. Additionally, the pressing plate 61 has a threaded hole 63 communicating with the sliding groove 47. The threaded rod 64 sequentially passes through a washer 65, the perforation 55, and the sliding groove 47, with one end being threaded into the threaded hole 63. The handle 66 is fixed to the opposite end of the handle 64 for driving the threaded rod 64 to rotate. The bushing 67 is fitted onto the threaded rod 64 and positioned within the sliding groove 47 for protecting the lateral support plate 40 from damage caused by the threaded rod 64. In this way, when the handle 66 is located at a lock position P3 as shown in FIG. 5, the lateral support plate 40 is forced tightly between the pressing portion 54 of the pivot seat 50 and the pressing plate 61 for preventing the lateral support plate 40 from moving relative to the worktable 12. When the handle 66 is located at an unlock position P4 as shown in FIG. 6, the lateral support plate 40 is released by the pressing portion 54 of the pivot seat 50 and the pressing plate 61, allowing the lateral support plate 40 to be moved relative to the worktable 12 through the sliding groove 47.

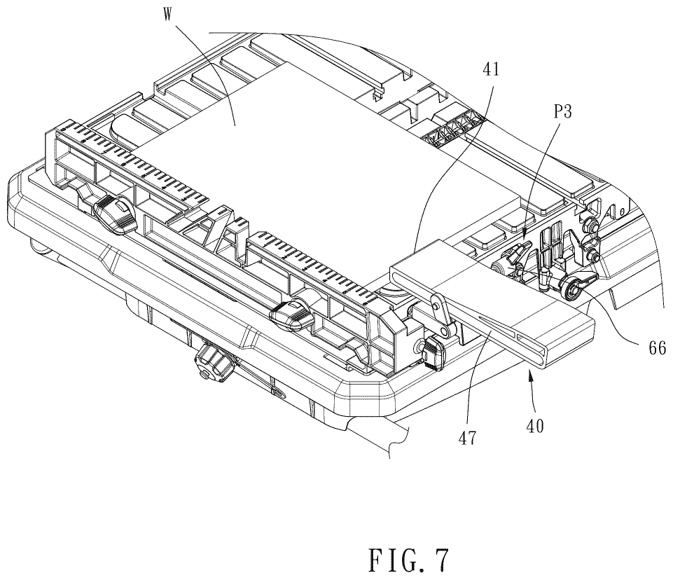

In actual operation, first adjust the position of the lateral support plate 40 according to the size of the workpiece W. Then, move the handle 66 to the unlocked position P4 as shown in FIG. 6. Next, adjust the position of the lateral support plate 40 through the sliding groove 47 until the first end surface 41 of the lateral support plate 40 firmly contacts one side of the workpiece W, as shown in FIG. 7. Afterward, move the handle 66 to the locked position P3 as shown in FIG. 7. At this point, the lateral support plate 40 provides effective lateral support to the workpiece W, ensuring the workpiece W remains stable during the cutting operation.

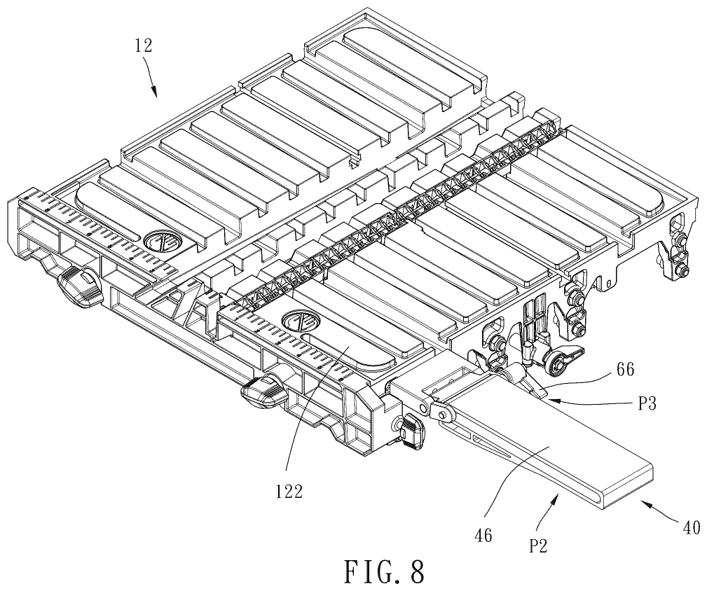

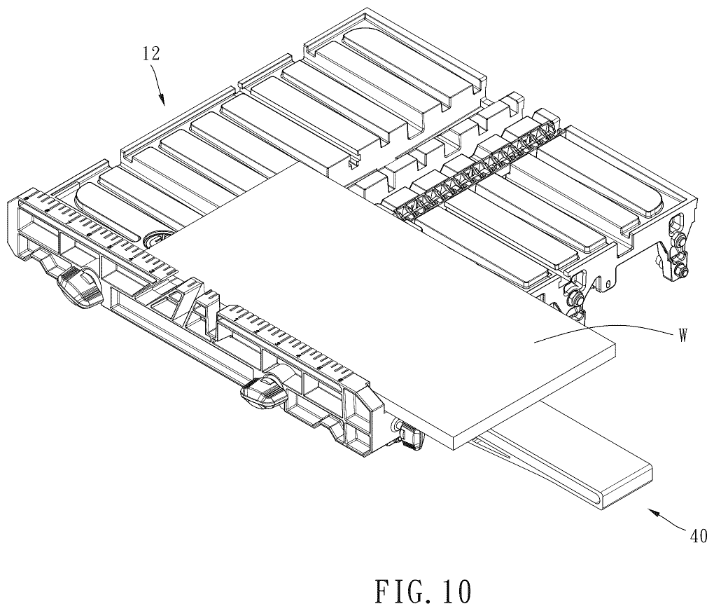

On the other side, when the handle 66 is located at the unlock position P4 as shown in FIG. 6, in addition to adjusting the position through the sliding groove 47, the lateral support plate 40 can also be flipped between a first position P1 and a second position P2 through the pivot seat 50. When the lateral support plate 40 is located at the first position P1 as shown in FIG. 6, the lateral support plate 40 is located above the worktable 12, and the bottom surface 46 of the lateral support plate 40 faces towards the working plane 122 of the worktable 12. At this point, the position of the lateral support plate 40 can be adjusted through the sliding groove 47. When the lateral support plate 40 is located at the second position P2 as shown in FIG. 8, the lateral support plate 40 protrudes from the lateral side 124 of the worktable 12, and the bottom surface 46 of the lateral support plate 40 faces upward and is flushed with the working plane 122 of the worktable 12. Further, the stop portion 56 of the pivot seat 50 is abutted against the bottom surface 36 of the fixed seat 30, so that the lateral support plate 40 is positioned to avoid excessive flipping. Thereafter, move the handle 66 to the lock position P3 as shown in FIG. 8. At this time, as shown in FIG. 10, the lateral support plate 40 can be used as an extension platform to assist the worktable 12 in providing support for longer workpieces W.

As indicated above, the lateral support device 20 of the present invention can adjust the position of the lateral support plate 40 according to workpieces W of different sizes, so that the lateral support plate 40 can provide effective lateral support to workpieces W of different sizes for solving issues with incomplete cross-sections. Additionally, the lateral support device 20 of the present invention can also be flipped outward to serve as an extension platform to provide an auxiliary support effect for the long workpiece W, thereby enhancing processing convenience.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lateral support device for use with a tile cutter, the tile cutter comprising a worktable, the lateral support device comprising:
a fixed seat for mounting to a lateral side of the worktable;
a lateral support plate having a first lateral surface, a second lateral surface opposite to the first lateral surface, and a sliding groove passing through the first and second lateral surfaces;
a pivot seat pivotally connected with the fixed seat and having a pressing portion arranged adjacent to the first lateral surface of the lateral support plate, and a perforation passing through the pressing portion and communicating with the sliding groove of the lateral support plate; and
a lock assembly including a pressing plate detachably connected to the pivot seat and arranged adjacent to the second lateral surface of the lateral support plate and having a threaded hole communicating with the sliding groove, a threaded rod passing through the perforation and the sliding groove and having one end threaded with the threaded hole, and a handle fixed to an opposite end of the threaded rod, wherein when the handle is located at a lock position, the lateral support plate is forced tightly between the pressing portion of the pivot seat and the pressing plate, preventing the lateral support plate from moving relative to the worktable, and when the handle is located at an unlock position, the lateral support plate is released by the pressing portion of the pivot seat and the pressing plate, allowing the lateral support plate to be moved relative to the worktable through the sliding groove.

2. The lateral support device as claimed in claim 1, wherein the lateral support plate further includes a first end surface, a second end surface, a top surface, and a bottom surface; the first and second end surfaces are connected to two opposite ends of the first and second lateral surfaces, respectively; an outer periphery of the top surface and an outer periphery of the bottom surface are connected to the first lateral surface, the second lateral surface, the first end surface, and the second end surface, respectively; the sliding groove is located between the first end surface, the second end surface, the top surface, and the bottom surface.

3. The lateral support device as claimed in claim 2, wherein when the handle is located at the unlock position, the lateral support plate is flippable through the pivot seat between a first position where the lateral support plate is located above the worktable, and the bottom surface of the lateral support plate faces towards a working plane of the worktable, and a second position where the lateral support plate protrudes from the lateral side of the worktable, and the bottom surface of the lateral support plate is flushed with the working plane of the worktable.

4. The lateral support device as claimed in claim 3, wherein when the lateral support plate is located at the second position, a stop portion of the pivot seat is abutted against a bottom surface of the fixed seat.

5. The lateral support device as claimed in claim 1, wherein the pressing plate has an insertion block inserted into an insertion groove of the pivot seat.
